(19) United States
(12) Patent Application Publication
(10) Pub. No.: US 2009/0167099 A1
(43) Pub. Date: Jul. 2, 2009

(54) Switch Device for Switching Different Type Signals

(76) Inventor: Chung-Ta Chin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/326,071

(22) Filed: Dec. 1, 2008

(30) Foreign Application Priority Data
Dec. 28, 2007 (TW) 096150876

(51) Int. Cl. H02B 1/24

(52) U.S. Cl. 307/125

(57) ABSTRACT

A switch device for switching different signal types includes a signal input unit for receiving a signal; a detection unit, coupled to the signal input unit, for generating a first control signal and a second control signal according to a signal type of the signal received by the signal input unit; and a switch unit, coupled to the signal input unit and the detection unit, for switching the signal input unit to either couple to a first signal processing unit or a second signal processing unit according to the first control signal and the second control signal outputted by the detection unit.

### BACKGROUND OF THE INVENTION

1. Field of the Invention

The present invention relates to a switch device for switching signals of different type, and more particularly, to a switch device that switches a received signal to a corresponding signal processing unit by detecting a type of the received signal.

2. Description of the Prior Art

For signals of a same type, digital or analog switches, such as multiplexers, etc., are generally employed to switch signals received from a same input terminal to output to a corresponding signal processing unit. Even for high-speed signals that require low turn-on impedance, e.g. PCIE interface signals, there also exists high-quality quick switches, i.e. PCIE switches, for switching the PCIE interface signals for use of various peripheral equipment or interfaces, such as graphical cards, network cards, etc.

However, for signals of different type, signals received from a same input terminal can only be switched manually to a corresponding back-end device since no efficient switch devices have been developed at the present time. For example, fool-proof designs of an RJ-45 network socket are generally not good enough, so a phone line plug of a type similar to a network plug, e.g. an RJ-11 plug, can be easily inserted into the network socket. Since a phone-line signal may contain a DC operating voltage of a dozen volts and an AC ring signal of about a hundred volts while a network signal contains a low voltage differential signal, these two signal types are greatly different from each other. Thus, when the phone line plug is wrongly inserted into the network socket, not only may back-end electronic devices of the network socket be damaged due to inability to bear such high voltages, but the phone-line circuit loop may also enter a short-circuit state, causing the phone line to appear to be engaged.

Thus, if a type of the signals received from the same input terminal can be detected in a timely manner and switched to a corresponding signal processing unit, not only can damage to the back-end devices due to reception of the wrong signals be prevented, but the number of sockets and the space being occupied can further be reduced as well.

### SUMMARY OF THE INVENTION

It is therefore an objective of the present invention to provide a switch device for switching different type signals.

According to the present invention, a switch device for switching different type signals is disclosed. The switch device includes a signal input unit, a detection unit and a switch unit. The signal input unit is utilized for receiving a signal. The detection unit is coupled to the signal input unit, and is utilized for generating a first control signal and a second control signal according to a type of the signal received by the signal input unit. The switch unit is coupled to the signal input unit and the detection unit, and is utilized for switching the signal input unit to either couple to a first signal processing unit or a second signal processing unit according to the first control signal and the second control signal outputted by the detection unit.

According to the present invention, a switch device for switching a network signal and a phone-line signal is further disclosed. The switch device includes a socket connector, a detection unit and a switch unit. The socket connector is utilized for receiving one of the network signal and the phone-line signal. The detection unit is coupled to the socket connector, and is utilized for generating a first control signal and a second control signal according to a type of the signal received by the socket connector. The switch unit is coupled to the socket connector and the detection unit, and is utilized for switching the socket connector to either couple to a network signal processing unit or a phone-line signal processing unit according to the first control signal and the second control signal outputted by the detection unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a switch device for switching two different type signals according to an embodiment of the present invention.

FIG. 2 is a schematic diagram of a switch device for switching a network signal and a phone-line signal according to an embodiment of the present invention.

### DETAILED DESCRIPTION

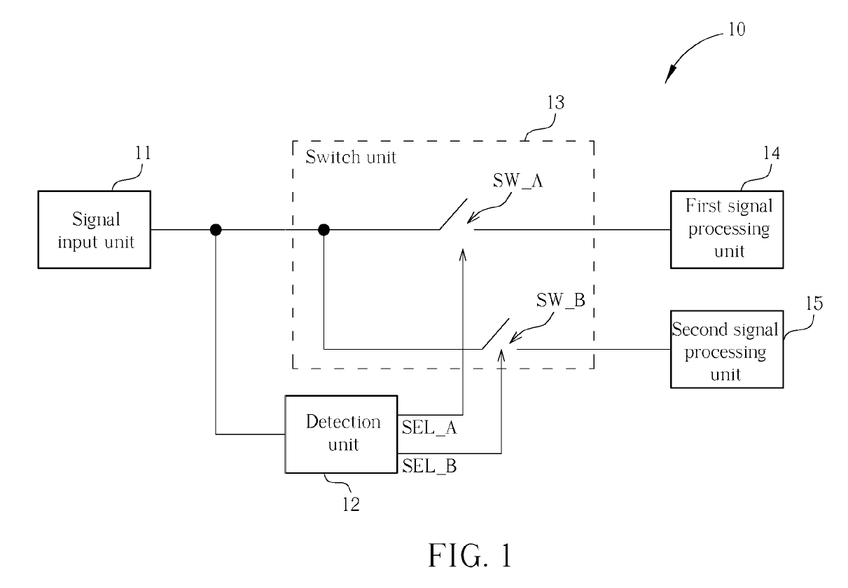

Please refer to FIG. 1. FIG. 1 is a schematic diagram of a switch device 10 for switching two different types of signals according to an embodiment of the present invention. The switch device 10 includes a signal input unit 11, a detection unit 12 and a switch unit 13. The signal input unit 11 is utilized for receiving a signal that has one of the two different signal types. The detection unit 12 is coupled to the signal input unit 11, and is utilized for generating a first control signal SEL_A and a second control signal SEL_B according to a type of the signal received by the signal input unit 11. The switch unit 13 is coupled to the signal input unit 11 and the detection unit 12, and is utilized for switching the signal input unit 11 to either couple to a first signal processing unit 14 or a second signal processing unit 15 according to the first control signal SEL_A and the second control signal SEL_B outputted by the detection unit 12.

The switch unit 13 further includes a first switch SW_A and a second switch SW_B. The first switch is coupled between the signal input unit 11 and the first signal processing unit 14, and is utilized for controlling electrical connection between the signal input unit 11 and the first signal processing unit 14 according to the first control signal SEL_A. The second switch SW_B is coupled between the signal input unit 11 and the second signal processing unit 15, and is utilized for controlling electrical connection between the signal input unit 11 and the second signal processing unit 15 according to the second control signal SEL_B. Preferably, the first switch SW_A and the second switch SW_B are preset to an open-circuit state, so as to prevent the back-end signal processing units from being damaged at the time the signal input unit 11 receives the said signal.

Thus, in the embodiment of the present invention, the switch device 10 can detect the signal type of the received signal and switch the received signal to the related signal processing unit, so that not only can damage to the back-end devices due to reception of the wrong signals be prevented, but the number of sockets and the space being occupied can be reduced as well.

Please note that the switch device 10 is not limited in manner of realization, and that any devices having the said function of switching different type signals can be considered to be in the scope of the present invention. For example, the detection unit 12 can be realized in hardware, such as by a voltage detection circuit or a current detection circuit in light of distinction between the two different type signals possibly received, or can be realized in software, such as by detecting an auto-negotiation mechanism in the received signal, etc. The first switch SW_A and the second switch SW_B can then be realized by transistor switches or a combination of some basic logic circuits. Additionally, to give an example, the said different types of signals in the embodiment of the present invention can be a combination of a phone-line signal and a network signal, an antenna signal and an audio signal, a USB interface signal and an IEEE 1394 interface signal, and so on.

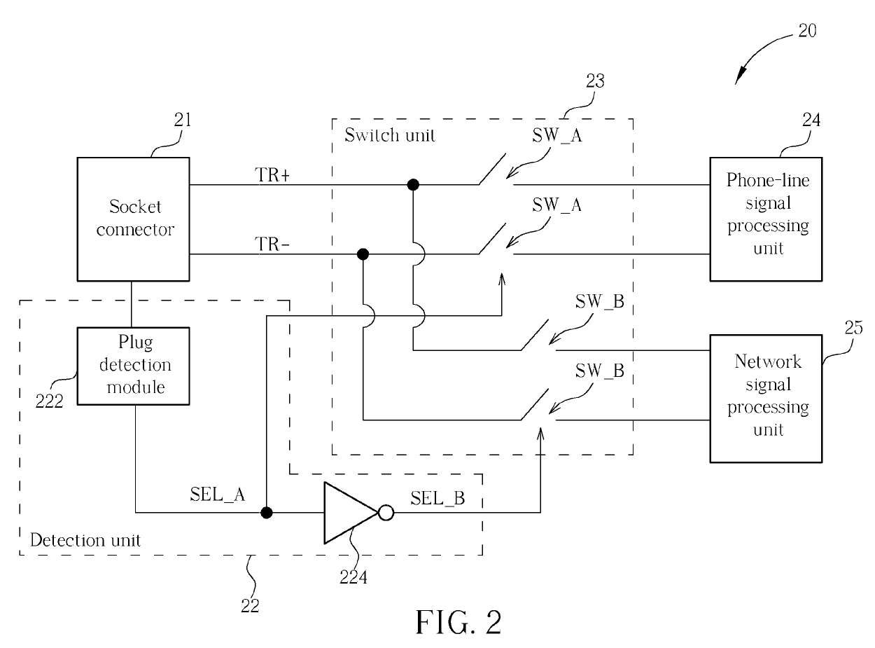

For example, please refer to FIG. 2. FIG. 2 is a schematic diagram of a switch device 20 for switching a network signal and a phone-line signal according to an embodiment of the present invention. The switch device 20 is similar to the switch device 10 of FIG. 1, and includes a socket connector 21, a detection unit 22 and a switch unit 23. The socket connector 21 is preferred to be an RJ-45 network socket connector, and is capable of accommodating a network plug or a phone-line plug for receiving the network signal or the phone-line signal. For brevity, FIG. 2 merely shows a pair of signal wires TR+ and TR− that are commonly used by the network signal and the phone-line signal. The detection unit 22 further includes a plug detection module 222 and an inverter 224. The plug detection module 222 is installed in the socket connector 21, and is utilized for generating a detection signal to output as a first control signal SEL_A according to an inserted plug type of the socket connector 21. The inverter 224 is coupled to the plug detection module 222, and is utilized for performing an inverse operation on the detection signal to output as a second control signal SEL_B. The switch unit 23 further includes a first switch SW_A and a second switch SW_B. The first switch SW_A and the second switch SW_B are coupled to the socket connector 21, respectively, and are utilized for switching the socket connector 21 to either couple to a phone-line signal processing unit 24 or a network signal processing unit 25 according to the first control signal SEL_A and the second control signal SEL_B outputted by the detection unit 22.

Thus, by determining the inserted plug type of the socket connector 21, the signal type received by the socket connector 21 can be detected, so as to switch the received signal of the socket connector 21 to the related back-end signal processing unit. For example, when a phone-line plug is inserted into the socket connector 21, the plug detection module 222 can generate a high voltage level of the detection signal to make the first switch SEL_A and the second switch SW_B enter into a short-circuit state and an open-circuit state, respectively, so as to output the received signal of the socket connector 21 to the phone-line signal processing unit 24. Conversely, when a network plug is inserted, the switch device 20 then switches the received signal of the socket connector 21 to the network signal processing unit 25 according to a voltage level of the detection signal generated by the plug detection module 222.

Therefore, compared with the prior art, when the phone-line plug is inserted into the network socket, the situations in which the back-end electronic devices of the network socket are damaged due to reception of the wrong signal and the phone-line circuit loop is shorted to cause the phone line to seem to be engaged can be improved. In addition, since the signal type received by the socket connector can be detected and switched to the correct signal processing unit in the embodiment of the present invention, the number of required sockets can be reduced as well.

As mentioned above, the received signal can be switched to the corresponding signal processing unit by detecting the signal type of the received signal in the embodiment of the present invention, so that not only the back-end devices can be prevented from being damaged due to reception of the wrong signals, but also the number of sockets and the space being occupied can be reduced as well.

Those skilled in the art will readily observe that numerous modifications and alterations of the device and method may be made while retaining the teachings of the invention.

What is claimed is:

1. A switch device for switching different signal types, comprising:
a signal input unit for receiving a signal;
a detection unit, coupled to the signal input unit, for generating a first control signal and a second control signal according to a type of the signal received by the signal input unit; and
a switch unit, coupled to the signal input unit and the detection unit, for switching the signal input unit to either couple to a first signal processing unit or a second signal processing unit according to the first control signal and the second control signal.

2. The switch device of claim 1, wherein the detection unit is a voltage detection unit.

3. The switch device of claim 1, wherein the detection unit is a current detection unit.

4. The switch device of claim 1, wherein the detection unit is implemented by software.

5. The switch device of claim 1, wherein the switch unit comprises:
a first switch, coupled between the signal input unit and the first signal processing unit, for controlling electrical connection between the signal input unit and the first signal processing unit according to the first control signal; and
a second switch, coupled between the signal input unit and the second signal processing unit, for controlling electrical connection between the signal input unit and the second signal processing unit according to the second control signal.

6. The switch device of claim 5, wherein the first switch and the second switch are individually transistor switches.

7. The switch device of claim 5, wherein the first switch and the second switch are preset to an open-circuit state.

8. A switch device for switching a network signal and a phone-line signal, the switch device comprising:
a socket connector for receiving one of the network signal and the phone-line signal;
a detection unit, coupled to the socket connector, for generating a first control signal and a second control signal according to a type of the signal received by the socket connector; and
a switch unit, coupled to the socket connector and the detection unit, for switching the socket connector to either couple to a network signal processing unit or a phone-line signal processing unit according to the first control signal and the second control signal.

9. The switch device of claim 8, wherein the socket connector is utilized for accommodating a network plug to transmit the network signal.

10. The switch device of claim 8, wherein the socket connector is utilized for accommodating a phone-line plug to transmit the phone-line signal.

11. The switch device of claim 8, wherein the detection unit comprises:
a plug detection module, installed in the socket connector, for generating a detection signal to output as the first control signal according to an inserted plug type of the socket connector; and
an inverter, coupled to the plug detection module, for performing an inverse operation on the detection signal to output the second control signal.

12. The switch device of claim 8, wherein the switch unit comprises:
a first switch, coupled between the socket connector and the network signal processing unit, for controlling electrical connection between the socket connector and the network signal processing unit according to the first control signal; and
a second switch, coupled between the socket connector and the phone-line signal processing unit, for controlling electrical connection between the socket connector and the phone-line signal processing unit according to the second control signal.

13. The switch device of claim 12, wherein the first switch and the second switch are individually transistor switches.

14. The switch device of claim 8, wherein the first switch and the second switch are preset to an open-circuit state.
